(19) United States
(12) Patent Application Publication
(10) Pub. No.: US 2008/0313034 A1
(43) Pub. Date: Dec. 18, 2008

(54) Credit item tracking system

(76) Inventor: Kurt Wise, Racine, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/811,686

(22) Filed: Jun. 12, 2007

(51) Int. Cl. G06Q 30/00

(52) U.S. Cl. 705/14

(57) ABSTRACT

A transaction system comprising: a participating vendor tracking mechanism that identifies at least one participating vendor which has authorized at least one certificate to be sold at a face value determined by a promotional campaign and rate plan; a purchase interface that generates a request by a customer for at least one certificate in real time; and a credit tracking system whereby credits are issued to a participating vendor for each certificate authorized in real time.

### FIELD OF INVENTION

This invention relates to the field of business barter, and more specifically to a system to track revenue generated by issuing certificates to the general public in exchange for credit items.

### BRIEF DESCRIPTION OF THE DRAWINGS

FIG. 1 is an overview of one embodiment of a certificate and credit item tracking system which issues certificates in real time in exchange for credit items that may be exchanged or redeemed for cash or goods and services.

FIG. 2 illustrates the revenue distribution feature of the certificate and credit item tracking system described herein, which allocates payments received for certificates to multiple revenue distribution recipients in real time.

FIG. 3 shows an alternate embodiment of a method of issuing certificates in real time in exchange for credit items that may be redeemed for cash or goods and services which further includes a mechanism for tracking and validating customer information.

### BACKGROUND

Businesses may enter into advertising or promotional programs to increase customer patronage. However, if the business pays for advertising or promotional services and customer patronage does not increase, directly or indirectly, an advertising or promotional program is not cost effective. Thus, there is an inherent element of risk in most paid promotional programs since a business cannot know in advance how many additional customers such programs will bring. It is desirable to have an advertising or promotional program which decreases the amount of risk associated with advertising and promotional expenditures.

Traditionally, certificates, coupons and promotional codes are among the methods use to track and associate customer patronage and the effectiveness of particular advertising and promotional campaigns.

Businesses which sell goods and services to the general public generally also have a need to purchase goods and services from other businesses such as inventory, advertising and media services and equipment.

It is thus desirable to implement a system where businesses can both track the effectiveness of advertising and promotional campaigns, and can earn income from the sale of certificates either in the form of cash or for credits which they can exchange other products and services they use in their businesses.

With respect to the present invention, the following terms are used to describe exemplary embodiments of the invention:

As used herein, the term “certificate” means is any data or datum capable of associating a monetary or credit value with a particular customer and/or transaction and which contains data indicating the dollar value and transaction terms for which the certificate will be accepted by a participating vendor. A certificate may be a paper certificate, an electronically transmitted file such as an e-mail or file maintained on a computer or terminal, checking account information, a credit card number or other account number, a gift card, a rechargeable gift card, a token, a numeric code, a bar code, bio-informatics data, a code word, a digital signature, a sequence known to the purchaser or vendor, or other data capable of being associated with a commercial transaction, including combinations thereof.

As used herein, the term “certificate order fulfillment mechanism” means one or more devices configured and adapted individually or in combination to be capable of associating a certificate with a customer. One example of a certificate order fulfillment mechanism is a customer creating a secure, authorized certificate on a personal computer in their home, whereby the personal computer serves as the certificate order fulfillment mechanism.

As used herein, the term “credit item” means any data or datum capable of associating a monetary or credit value with information about the dollar value of the credit item or the terms and conditions for redeeming it.

As used herein, the term “credit item tracking mechanism” means any device capable of tracking information relating to credit items, issuance of credit items or redemption of credit items. As used herein, a credit tracking mechanism may include a server, memory device, keyboard, a typewriter, cash register, a touch-sensitive computer interface, a voice recognition device, the certificate itself, a paper document, a wireless device, laptop computer, mobile phone, personal information device, personal digital assistant, hand-held device, network appliance, pager, an analog device or a device used manually, microphones, touch-sensitive displays, transducer card readers, magnetic or paper tape readers, tablets, styluses, voice or handwriting recognizers, a server, a mechanism capable of reading biological information, a document reader or scanner, any other recording device commonly known and used in the art, and including combinations thereof.

As used herein, the term “certificate request” means any form of communication by a customer to initiate the purchase of a certificate.

As used herein, the term “customer” means an individual or entity that receives, purchases, or uses a certificate associated with a monetary amount and a participating vendor.

As used herein, the term “customer information” means any information about an individual or entity that receives or uses a certificate associated with a monetary amount and a participating vendor. Such information may include the name, address, phone, number, e-mail, age, gender, purchasing history or preferences, information about how the customer learned about the participating vendor or promotions offered by the participating vendor or any other information about the customer or transaction capable of being tracked in a database, including combinations thereof.

As used herein, the term “customer patronage” means customers patronizing a business or any change in activity to a business which impacts its revenue or potential revenue.

As used herein, the term “face value” means a monetary amount assigned to the certificate which may be applied to the purchase of good and services by vendors. The face value may be more, less or equal to the payment amount.

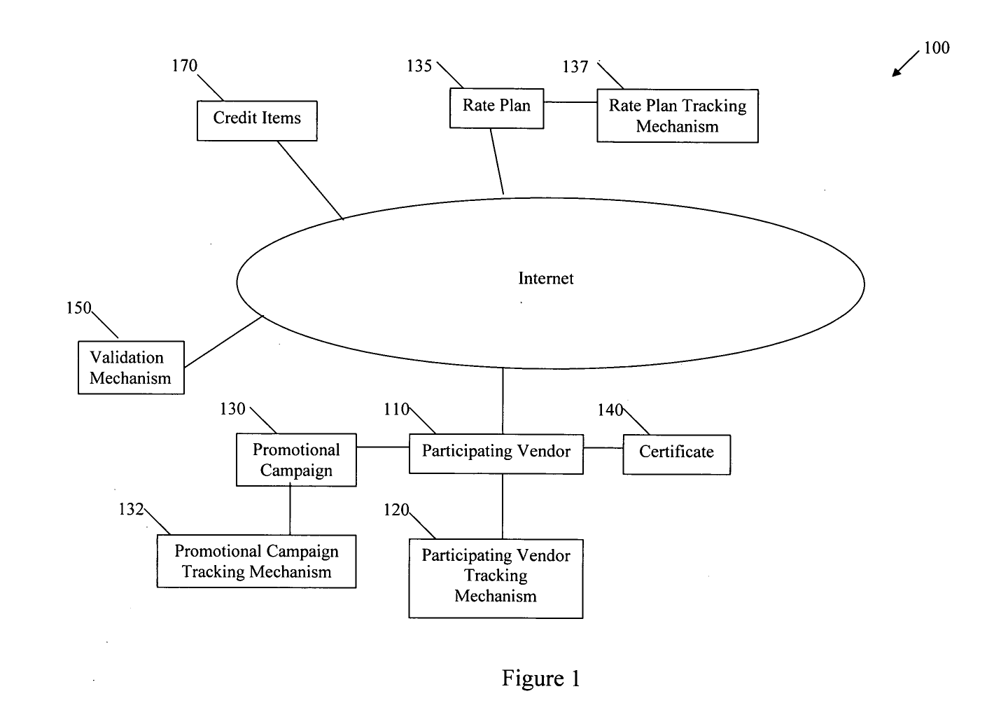

As used herein, the term “issuing mechanism” means any device or containing information relating to authorizing and issuing one or more certificates, including a server memory device, keyboard, a typewriter, cash register, a touch-sensitive computer interface, a voice recognition device, the certificate itself, a paper document, a wireless device, laptop computer, mobile phone, personal information device, personal digital assistant, hand-held device, network appliance, pager, an analog device or a device used manually, microphones, touch-sensitive displays, transducer card readers, magnetic or paper tape readers, tablets, styluses, voice or handwriting recognizers, a server, a mechanism capable of reading biological information, a document reader or scanner, any other recording device commonly known and used in the art, and including combinations thereof. In the embodiment of the certificate and credit item tracking system shown in FIG. 1, the issuing mechanism issues a certificate directly to a customer, but in other embodiments, a certificate may be issued to one or more account issuers who subsequently associate certificates with customer.

As used herein, the term “media service provider” means any provider of promotional, communication or advertising services for individuals, vendors or businesses, including a provider of print media, radio, television, promotional items or a networking venue such as a professional organization or chamber of commerce, or a provider of any venue through which a business or individual may promote or make potential customers or purchasers aware of their services.

As used herein, the term “participating vendor” is any seller of goods and/or services which accepts a certificate a form of payment, and “multiple participating vendors,” as the term is used herein, means a plurality of participating vendors that have no commercial or economic affiliation with each other, but may also include vendors that do have a common economic affiliation, ownership, or characteristic with each other.

As used herein, the term “participating vendor tracking mechanism” means one or more devices configured individually or in combination and adapted or otherwise capable of tracking vendors which issue certificates.

As used herein, the term “payment receiving mechanism” may be one or more devices adapted individually or in combination and configured or otherwise capable of recording and transmitting payment information and allocating such information according to the parameters and requirements of a rate plan including a memory device, a keyboard, a typewriter, cash register, a touch-sensitive computer interface, a voice recognition device, the certificate itself, a paper document, a wireless device, laptop computer, mobile phone, personal information device, personal digital assistant, hand-held device, network appliance, pager, an analog device or a device used manually, microphones, touch-sensitive displays, transducer card readers, magnetic or paper tape readers, tablets, styluses, voice or handwriting recognizers, a server, a mechanism capable of reading biological information, a document reader or scanner, any other recording device commonly known and used in the art, and including combinations thereof. As used herein a rate plan is an allocation of payment for a certificate among one or more commission recipients, based upon policies, percentages and statistical information maintained by the rate plan tracking mechanism.

As used herein, the term “point-of-use” means a location, business, or contact at which a customer exchanges a certificate for goods and/or services.

As used herein, the term “promotional campaign” means the monetary amount of the certificates or other financial commitment that a participating vendor will invest in entering into the certificate and credit item tracking system described herein.

As used herein, the term “promotional program” means any program of advertising or promotion intended to increase customer patronage for a business.

As used herein, the term “purchase interface” tracking system means one or more devices configured individually to receive a certificate request.

As used herein, the term “rate plan” means a pre-determined formula or criteria for allocating an amount received as payment for a certificate to one or more revenue recipients based on one or more policies, promotional campaigns or other directives in effect.

As used herein, the term “rate plan tracking mechanism” means one or more devices configured individually or in combination and adapted or otherwise capable of tracking an allocation, in real time, the amount received as payment for a certificate to one or more revenue distribution recipients based on one or more policies, promotional campaigns, or other directives in effect. A rate plan tracking mechanism may include a server, keyboard, a typewriter, cash register, a touch-sensitive computer interface, a voice recognition device, the certificate itself, a paper document, a wireless device, laptop computer, mobile phone, personal information device, personal digital assistant, hand-held device, network appliance, pager, an analog device or a device used manually, microphones, touch-sensitive displays, transducer card readers, magnetic or paper tape readers, tablets, styluses, voice or handwriting recognizers, a server, a mechanism capable of reading biological information, a document reader or scanner, any other recording device commonly known and used in the art, and including combinations thereof.

As used herein, the term “real time” means a time span between when a customer initiates a transaction and the processing of the transaction is completed within a pre-designated time frame or specified time duration based on the time required to transfer and process data electronically.

As used herein, the term “revenue distribution recipient” includes, but is not limited to, the following:
Sales agents or persons or entities involved in the selling, transfer, or promotion of accounts or goods and services capable of being associated and tracked using the system described herein;
Nonprofit entities, charitable organizations, or other tax exempt and non-exempt entities and organizations to which a fixed amount or a percentage of the payment may be donated pursuant to a rate plan;
Management personal;
Vendors of goods and services;
Representatives of vendors of goods and services, profit, or nonprofit organizations and other public and private entities;
A customer;
Administrative entities and personnel;
A trade association or group of vendors having a common characteristic or affiliation; and
Media entities and individuals and entities associated with the promotion, publicity, publication, and representation of commission recipients, vendors, and users of the certificate and credit item tracking system described herein.

As used herein, the term “validation mechanism” means one or more devices configured individually or in combination and adapted to maintain information about certificates including the initial monetary value, the recharge value and/or an updated value associated with each certificate reflecting transactions and monetary amounts associated to certificate by a payment receiving mechanism. A validation mechanism may further be capable of updating a certificate in real time when the certificate is used in a transaction or an event occurs which affects the value of the certificate.

### DETAILED DESCRIPTION OF EMBODIMENTS OF THE INVENTION

For the purpose of promoting an understanding of the present invention, references will be made in the text hereof to embodiments of a method and system for tracking and allocating revenue from certificates issued pursuant to a media promotion campaign. It is to be understood, however, that the present invention may be embodied in various forms. Therefore, specific details disclosed herein are not to be interpreted as limiting, but rather as a basis for the claims and as a representative basis for teaching one skilled in the art to employ the present invention. One of ordinary skill in the art will readily appreciate that modifications do not depart from the spirit and scope of the present invention, some of which are mentioned in the following description.

With particular reference to the figures, the reader should also know that like numerals in different figures refer to the same elements of the embodiments. Moreover, it should be noted that each embodiment of the invention is not depicted by the figures.

In accordance with the practices of persons of ordinary skill in the art of computer programming, the present invention is described below with reference to acts and symbolic representations of operations or instructions that are performed by a processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals or biological signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by a CPU. The computer readable medium includes cooperating or interconnected computer readable medium, which exist exclusively on the processing system or be distributed among multiple interconnected processing systems that may be local or remote to the processing system.

FIG. 1 shows one embodiment of certificate and credit item tracking system 100 for generating and issuing certificates and tracking credit items. Participating vendor 110 is identified using participating vendor tracking mem(4Upromotional campaign 130 with participating vendor 110 and issues certificate 140 for an amount determined pursuant to rate plan 135. In the embodiment shown, participating vendor 110 incurs a cost for the advertising or promotional services only when a customer redeems certificate 140 when patronizing the business of participating vendor 110. The cost incurred by participating vendor 110 is the face value of certificate 140. In the embodiment shown, customers often purchase goods and services from participating vendor 110 in excess of the face value of certificate 140 when patronizing the business and also return to purchase goods and services at future dates after becoming familiar with the business on the occasion the certificate 140 is used. Certificate 140 is sold for a discounted amount which is generally less than the face value of certificate 140. The discounted amount received is tracked as revenue. The discounted amount for which certificate 140 is used to determine, in real time, the value of credit items 170 to which participating vendor 110 is entitled as a result of the sale of certificate 140 and to allocate the revenue received from the sale of certificate 140 among various individuals and entities entitled to a portion of the revenue in real time (known as “revenue distribution recipients”).

In the embodiment shown, when a customer presents certificate 140 to participating vendor 110 at the point of use, validation mechanism 150 updface value of certificate 140 in real time to reflect that certificate 140 has been used in a transaction. In other embodiments of the invention, validation mechanism 150 may validate information about the customer, transaction amount, value of certificate 140, authenticity of certificate 140, or any other information about certificate 140 capable of being tracked, verified, updated, or authenticated. Other embodiments may omit a validation mechanism or validate more or less information.

In the embodiment shown, participating vendor 110 is a restaurant which issues certificate 140 in exchange for credit items 170 which participating vendor 110 redeems for radio time from a media service provider promoting the restaurant and the availability of certificates 140 from the restaurant.

In the embodiment shown, the face value of certificate 140 is for the purchase price of a meal as reflected on the restaurant menu. A customer has purchased certificate 140 at a predetermined discount of the face value of certificate 140 determined by rate promotional campaign 130 and rate plan 135. In the embodiment shown, the predetermined discount is fifty percent (50%) under rate plan 135. The amount predetermined discounted amount received for certificate 140 is treated as revenue to be allocated among various revenue distribution recipients. It should be understood, however, that in alternate embodiments of certificate and credit item tracking system 100, a customer could purchase certificate 140 at a predetermined discount which may be more, less, or equal to the face value.

In the embodiment shown, participating vendor tracking mechanism 120 tr′m(.Utr′m(.Utr′m(.Utracks vendors ′m(.Ucertificate 140 as a form of payment in online, retail, in-person, billed, open account, and other transactions.

In the embodiment shown, promotional campaign 130 may be changed and modified by an authorized administrator, or person having the authority to effectuate such changes using promotional campaign tracking mechanism 132.

In the embodiment shown, rate plan 135 may be changed and modified by an authorized administrator or person having the authority to effectuate such changes using rate plan tracking mechanism 137.

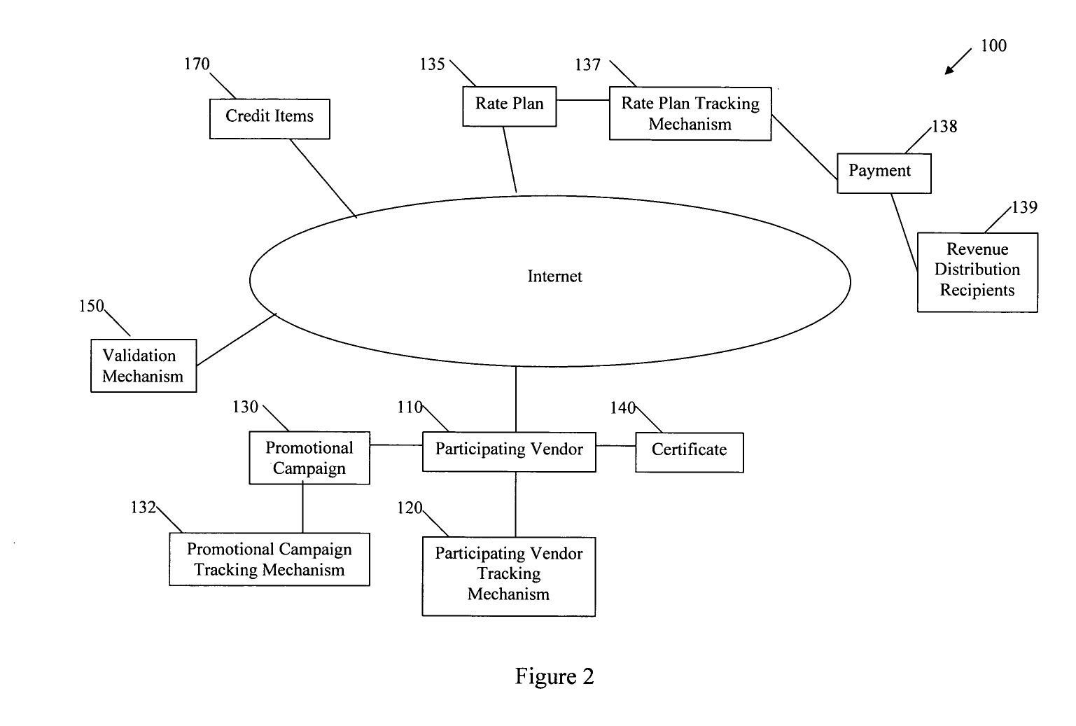

FIG. 2 illustrates the revenue distribution tracking feature of credit item tracking system 100 whereby rate plan tracking mechanism 137 allocates payment 138 received for certificate 140 to revenue distribution recipients 139 in real time.

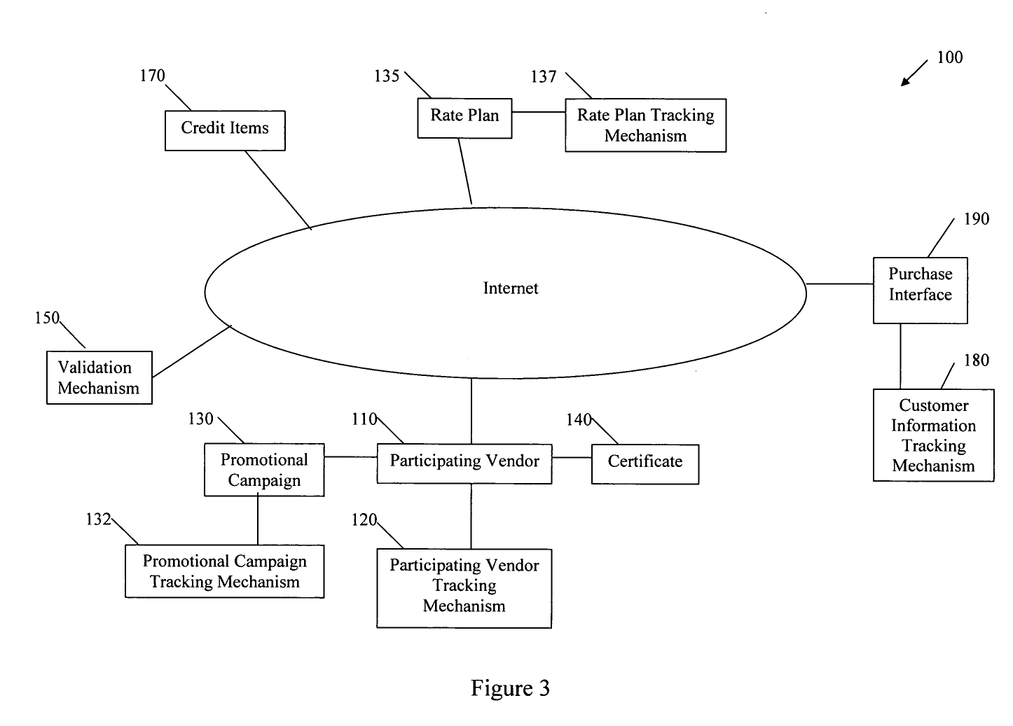

FIG. 3 shows an alternate embodiment of credit item tracking system 100 for issuing certificates 140 in real time in exchange for credit items that may be exchanged for cash or goods and services, which further includes customer information tracking mechanism 180 which is a server or other device maintained by an order fulfillment company and capable of receiving information generated by a customer using purchase interface 190. In the embodiment shown, customer information tracking mechanism 180 maintains data about customers, including information about account holder behaviors, including but not limited to purchases, purchase patterns, interest expressed in goods or services, and contacts with one or more identified vendors and storing at least some portion of the data in real time, allowing such data to be viewed on a computer interface. In other embodiments of the invention, customer information tracking mechanism 180 may associate additional identifying information with certificate 140, such as information sufficient to identify the customer, and/or may also identify the exact participating location where certificate 140 is being used. In other embodiments of the invention, customer information tracking mechanism 180 may track additional or alternate information such as security information, market research information, information about the number of transactions, types of transactions that have occurred at the location of the certificate input mechanism, information about events that may affect transactions at the location of certificate input mechanism, and/or information about one or more consumers involved in the transaction. Thus, one of ordinary skill in the art will recognize that the specific identifying information associated with certificate 140, or any other mechanism, can contain any of that information set forth herein, or any other identifying information, alone or in combination.

In the embodiment shown, the participating vendor 110 is a restaurant business. In other embodiments, participating vendor may be any business of the type defined herein.

While the certificate and credit item tracking system has been shown and described with respect to several embodiments in accordance with the present invention, it is to be understood that the same is not limited thereto. Many of the details referred to herein are given as examples, and the invention is of such scope to encompass many variations and modifications thereof as known to a person of ordinary skill in the art, and it is intended that the present invention not be limited to the details shown and described herein, but rather cover all such changes and modifications obvious to one of ordinary skill in the art.

What is claimed is:

1. A transaction system comprising:
a participating vendor tracking mechanism which identifies at least one participating vendor which has authorized at least one certificate to be sold at a face value determined by a promotional campaign and rate plan;
a purchase interface, said purchase interface generating a request by a customer for at least one certificate in real time; and
a credit tracking system whereby credits are issued to a participating vendor for each certificate authorized in real time.

2. The system of claim 1, wherein said system further includes a validation mechanism, said validation mechanism capable of updating said at least one certificate in real time.

3. The system of claim 2, wherein said validation mechanism further validates at least one piece of information, said at least one piece of information selected from a group comprised of a transaction amount, a value of said at least one certificate, an authenticity about said at least one certificate, and combinations thereof.

4. The system of claim 2, wherein said validation mechanism is capable of associating a certificate with identifying information, said identifying information selected from a group comprised of a credit card number, a customer name, an input mechanism, a date of purchase of said at least one certificate, a time of purchase of said at least one certificate, a transaction amount, security information, and market research information.

5. The system of claim 1, wherein said participating vendor tracking mechanism tracks which of said at least one participating vendor recognize said at least one certificate as a form of payment for a type of transaction selected from a group comprised of online sales, retail sales, in-person sales, billed sales, open account sales, and combinations thereof.

6. The system of claim 1, wherein said system further includes a validation mechanism, said validation mechanism tracking data about said customer and storing at least a portion of said data in real time and allowing said data to be viewed on a computer interface, said data selected from a group comprised of account holder behaviors, account holder purchases, account holder purchase patterns, and account holder interests expressed in goods or services or contacts with one or more identified participating vendors.

7. The system of claim 1, wherein said credit item tracking mechanism tracks said information about at least one credit item in real time.

8. The system of claim 1, wherein said system further includes a credit item tracking mechanism, said credit item tracking mechanism tracking information about at least one credit item.

9. The system of claim 1, wherein said system further includes a participating vendor tracking mechanism, said participating vendor tracking mechanism tracks information about participating vendors in real time.

10. The system of claim 1, wherein said certificate order fulfillment mechanism fulfills a certificate order in real time.

11. The system of claim 1, wherein said payment receiving mechanism further allocates payment to at least one revenue distribution recipient in real time.

12. The system of claim 1, wherein said system further includes a mechanism for converting said credit items to cash.

13. The system of claim 1, wherein said system further includes said mechanism for converting said credit items to goods and services.

14. A method of managing at least one unique identifying certificate comprising the steps of:
identifying at least one participating vendor using a vendor tracking mechanism;
associating at least one rate plan and one promotional campaign and at least one rate plan with at least one participating vendor;
receiving a certificate request;
associating at least one rate plan and at least one promotional campaign with said at least one certificate in real time;
associating a face value to said at least one unique identifying certificate in real time;
issuing said at least one certificate to at least one customer;
receiving and recording a payment amount from said at least one customer; and
crediting said payment amount to at least one revenue recipient based upon at least one of said at least one rate plan in real time.

15. The method of claim 14, further including the step of recording that said at least one unique identifying certificate has been used for a transaction in real time.

16. The method of 14, wherein said system further includes the step of validating a transaction.

17. The method of 14, wherein said system further includes the step of issuing said credit items to said participating vendor.

18. The method of 14, wherein said system further includes the step of redeeming a credit item from said participating vendor.

19. The method of 18, wherein said system further includes the step of redeeming a credit item from said participating vendor for cash.

20. The method of 14, wherein said system further includes the step of tracking customer information in a database.
